(19) United States
(12) Patent Application Publication
(10) Pub. No.: US 2007/0027875 A1
(43) Pub. Date: Feb. 1, 2007

(54) Computer system for database administration and graphical user interface for same

(76) Inventors: William G. Mitchell, Riverside, CA (US); Gary W. Almond, Moreno Valley, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/189,343

(22) Filed: Jul. 26, 2005

(51) Int. Cl. G06F 17/30

(52) U.S. Cl. 707/10

(57) ABSTRACT

An apparatus comprises a database administration interface and a graphical user interface configured to receive information regarding an organization, an organization evaluation, and an evaluation of the organization evaluation. The apparatus further comprises a database including a database schema configured to store information relating to the organization that is received by the database administration interface. The apparatus further comprises an organization evaluation module configured to assign a composite performance designation to the organization based on information relating to the organization that is stored in the database. The composite performance designation is stored in the database. The apparatus further comprises a plurality of distributed client interfaces configured to access and controllably display information stored in the database relating to the organization.

### COPYRIGHT RIGHTS

The present invention relates generally to a computer system configured to provide administrative services for a database, and more specifically to a computer system configured to administer a database containing records relating to evaluations of various types of organizations.

### FIELD OF THE INVENTION

The present invention relates generally to a computer system configured to provide administrative services for a database, and more specifically to a computer system configured to administer a database containing records received from distributed sources and including a graphical user interface for same.

### BACKGROUND OF THE INVENTION

While databases exist for storing a wide variety of information received from distributed sources, many conventional database structures are unable to provide convenient access to information users seek to locate in the database. Such database interfaces are often difficult to use, require extensive specialized training, and require knowledge of technical computer procedures that are counterintuitive for many users.

A wide variety of systems have been developed to evaluate organizations and to store information collected in the process of organizational evaluation. For example, guidebooks and other publications have been developed that evaluate establishments such as restaurants, hotels and cruises. As another example, professional organizations, such as bar associations and medical associations, often publish information regarding consumer complaints against their members. Systems such as these allow consumers to make more informed choices regarding the businesses and organizations they patronize, and allow businesses and organizations to refine their services based on feedback provided by their clientele.

In some systems, the evaluation is based at least in part on feedback from agents who visit the establishment being evaluated, and who rate the establishment using various objective and/or subjective criteria. For example, a hotel might be evaluated based on cleanliness, amenities, location and décor, while a restaurant might be evaluated based on the quality of the food, the level of service provided, and the dining atmosphere. Often the agent performing the evaluation (often referred to as the “professional evaluator”) is specifically trained to evaluate certain factors and to identify certain issues which, while important, are not immediately obvious to the average consumer.

In some systems, the evaluation is based at least in part on feedback from consumers who patronize the business. Such data can be collected using customer surveys, which can be administered at the business, online, telephonically, or through the mail. For example, in one arrangement, customers are sent surveys with questions asking for subjective feedback on the type of service they received from the business. Such data is often collected on the premise that the aggregate evaluation of dozens, or even hundreds, of reviewers is more reliable than an evaluation based on feedback from a single professional evaluator.

Computer-based systems for evaluating organizations have been developed, including online systems for evaluating Internet merchants. For example, websites have been developed that allow users to submit reviews and other feedback for online merchants; examples of such websites include www.epinions.com and www.bizrate.com. Additionally, many online retailers allow customers to submit feedback, often referred to as “customer reviews” regarding products sold by the retailer.

### SUMMARY OF THE INVENTION

While the conventional evaluation systems disclosed herein provide several useful features, they also suffer from several significant disadvantages. For example, systems that rely solely on feedback from a professional evaluator are not as broadly based as systems that rely on feedback from consumers. Likewise, systems that rely solely on feedback from consumers have a difficult time evaluating the many important issues that are not immediately obvious to consumers. Similarly, systems that rely solely on counting consumer complaints risk unfairly penalizing a business based on frivolous, unfounded or misinformed complaints. For example, websites that allow submission of customer reviews provide no assurances that the author of a particular review is providing information that is truthful, accurate or otherwise reliable.

Therefore, in accordance with the foregoing, an improved system for evaluating businesses and other organizations has been developed. Certain embodiments of the improved systems disclosed herein provide a broad-based evaluation of an organization in a way that provides consumers with an easy to understand letter grade based rating system. Optionally, such a system advantageously assigns a composite score or rating for an organization that is based on both subjective and objective professional evaluations, as well as feedback from consumers.

In an exemplary embodiment of the present invention, an apparatus comprises a database administration interface configured to receive information regarding an organization, a consumer complaint relating to the organization, and an evaluation of the consumer complaint. The apparatus further comprises a database configured to store information relating to the organization that is received by the database administration interface. The apparatus further comprises an organization evaluation module configured to assign a composite point value to the organization based on information relating to the organization that is stored in the database. The composite point value is stored in the database. The apparatus further comprises a plurality of client interfaces configured to access and controllably display information stored in the database relating to the organization.

In an exemplary embodiment of the present invention, a method of evaluating an organization comprises receiving a consumer complaint relating to the organization. The method further comprises evaluating the consumer complaint. The method further comprises assigning points to the organization based on the evaluation of the consumer complaint. The method further comprises evaluating an organization response to the consumer complaint. The method further comprises assigning points to the organization based on the evaluation of the organization response to the consumer complaint. The method further comprises compiling a cumulative score for the organization based on the points assigned to the organization.

In an exemplary embodiment of the present invention, a system comprises a first computer memory storing programmable instructions to receive a complaint relating to an organization from a consumer, and an evaluation of the complaint from a professional evaluator. The system further comprises a second computer memory storing programmable instructions to assign a composite score to the organization. The composite score is based at least in part on the evaluation of the complaint. The system further comprises a database configured to store the complaint, the evaluation of the complaint, and the composite score. The system further comprises a network system configured to connect a plurality of clients to the database. The plurality of clients are configured to controllably display at least a portion of data stored in the database.

In an exemplary embodiment of the present invention, a method of evaluating an organization comprises defining a first factor that relates to a characteristic of the organization. The method further comprises defining a second factor that relates to a characteristic of the organization. The method further comprises defining a first plurality of response categories for the first factor. The response categories have assigned thereto a point value. The method further comprises defining a second plurality of response categories for the second factor. The response categories have assigned thereto a point value. The method further comprises categorizing the organization into a selected one of the first plurality of response categories based upon the first factor, and assigning the point value associated with the selected response category. The method further comprises categorizing the organization into a selected one of the second plurality of response categories based upon the second factor, and assigning the point value associated with the selected response category. The method further comprises compiling a cumulative score for the organization based upon the assigned point values.

### BRIEF DESCRIPTION OF THE DRAWINGS

Exemplary embodiments of an organization evaluation system and methods are illustrated in the accompanying drawings, which are for illustrative purposes only. The drawings comprise the following figures, in which like numerals indicate like parts.

FIG. 1 is a schematic diagram illustrating selected components of an exemplary system for evaluating an organization.

FIG. 2A is a flowchart illustrating selected processes performed in an exemplary method for evaluating an organization.

FIG. 2B is a flowchart illustrating selected processes performed in an exemplary method for handling user queries regarding organizations.

FIG. 3 is an exemplary screen shot of an interface usable to search a database containing a plurality of organization evaluations.

FIG. 4 is a schematic screen shot of an exemplary interface usable to provide organization evaluation information to a user.

FIG. 5 is an exemplary screen shot of an interface usable to adjust the relative weight of a plurality of factors used to evaluate an organization.

FIG. 6 is an exemplary screen shot of an interface usable to manually override an automatically computed organization evaluation, and to view selected subcomponents of a composite score of an organization.

FIG. 7 is a schematic illustration of an exemplary organization database record that includes information regarding the evaluation of the organization.

### DETAILED DESCRIPTION OF PREFERRED EMBODIMENTS

Introduction.

Disclosed herein are improved systems and methods for evaluating an organization. As used herein, the term “organization” includes its ordinary meaning, and also encompasses businesses, nonprofit organizations, professional groups, sole proprietors, partnerships, and other providers of goods and/or services. Therefore, the systems and methods disclosed herein are usable to evaluate entities other than conventional business entities. Persons and entities that use the services of an organization are collectively referred to herein as “consumers”. As used herein “consumers” also includes other persons who use the organization evaluations, such as members of an industry watchdog group or a governmental regulatory agency.

Throughout this disclosure, the term “website” is used to refer to a user-accessible server site that implements the basic World Wide Web standards for the coding and transmission of hypertext documents. These standards currently include the hypertext markup language (HTML) and the hypertext transfer protocol (HTTP). The term “site” is not intended to imply a single geographic location, as certain websites or other network sites include multiple geographically distributed computer systems that are appropriately linked together. Furthermore, while this disclosure describes certain embodiments that use the Internet and related protocols, other networks, such as networked interactive televisions, and other protocols are used in other embodiments.

Additionally, unless otherwise indicated, the functions described herein are performable by software modules including executable code and instructions running on one or more general purpose computers. In an exemplary embodiment, the computers include one or more central processing units that execute program code and process data. The computers also optionally include memory, including one or more of volatile memory (such as random access memory for temporarily storing data and data structures during program execution), non-volatile memory (such as a hard disc drive, optical drive, or flash drive, for storing programs, data, and databases), and one or more network interfaces for accessing an intranet and/or Internet.

The computers optionally include a display for displaying user interfaces, data, photographs, images, and the like. In certain embodiments, the computers also include one or more user input devices, such as a keyboard, mouse, pointing device, microphone and the like, used to navigate, provide commands, enter information, and the like. However, other embodiments are implemented using special purpose computers, state machines, and/or hardwired electronic circuits. Additionally, the example processes described herein do not necessarily have to be performed in the described sequence, and not all states have to be reached or performed.

Furthermore, where this disclosure refers to “clicking on” a link or button, or pressing a key in order to provide a command or make a selection, in other embodiments the commands or selections are made using other input techniques, such as using voice input, pen input, or mouse input, including hovering over an input area, selecting menu options, and the like. Additionally, where certain processes and functions are described as being performed separately by a database application, a viewer application and/or other applications, in modified embodiments, these processes and functions are performed by the same application.

In one embodiment, a system for evaluating an organization is provided on a computer platform. In such embodiments, the organization evaluations are stored in a database managed by a database application that includes searching functionality, thereby allowing multiple evaluations to be sorted and compared. This allows both consumers and members of the evaluated organization to view all or selected portions of an evaluation in an online format from a location remote to the storage location. For example, in one embodiment, the evaluations are viewed using a viewer application that is configured to receive data from the Internet. The organization evaluations are optionally provided wholly or partially via a network, thereby further facilitating the provision of data to the evaluation system.

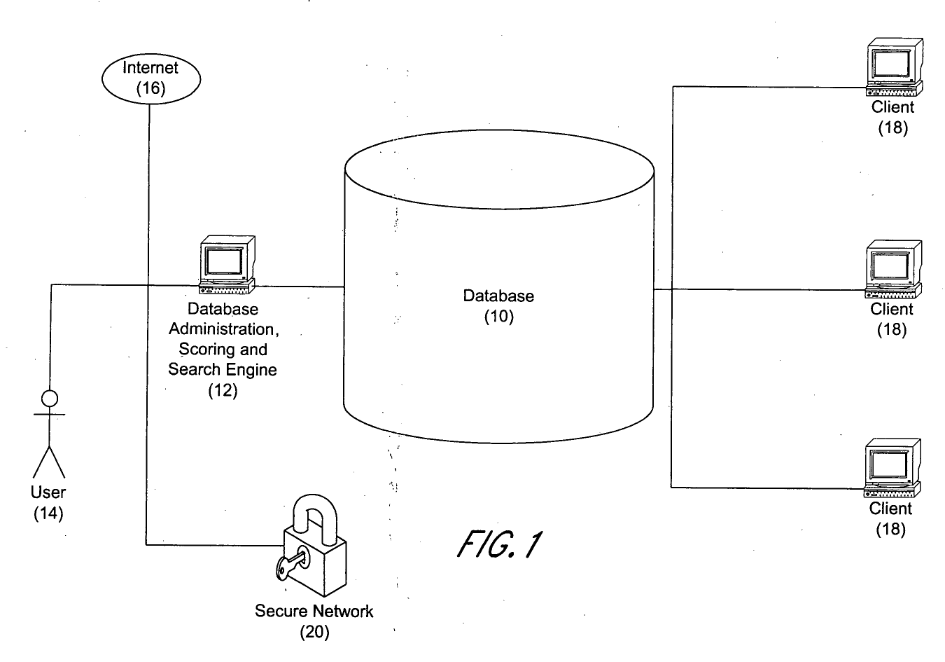

Selected components of an exemplary system for performing an evaluation of an organization are illustrated in FIG. 1. As illustrated, this system includes a database 10 connected to a database administration computer 12. The database stores complaints, scores, ratings, and other organization information such as contact information, amount of time the organization has been operating, and so forth. The database administration computer 12 is configured to manage certain aspects of the database, such as maintenance and organization tasks, searches, and new record generation. The database administration computer 12 is also configured to receive data regarding one or more organizations to be evaluated from one or more data sources. Exemplary data sources include user input 14, a network connection 20, or the Internet 16, where the networks optionally comprise a secure network connection in certain embodiments. The exemplary system illustrated in FIG. 1 further includes one or more clients 18 configured to receive information from the database 10. Optionally, the clients 18 use a viewer application to view and sort data stored in the database 10. In one embodiment, the viewer application comprises a browser that can render HTML pages, execute Java script, and perform other similar functions.

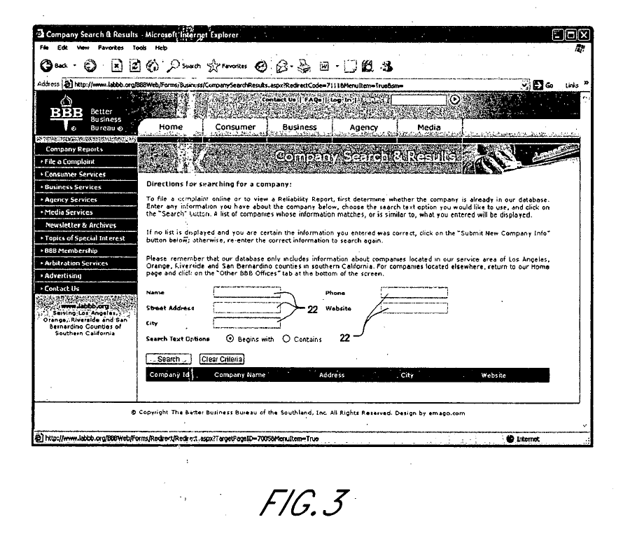

An exemplary embodiment of a graphical user interface accessible by clients 18 is provided in FIG. 3. The clients can be, by way of example, desktop computer, interactive televisions, smart phones, and so forth. As illustrated, this user interface provides users with fields 22 to enter information such as name, address, and website. Other fields, or fewer fields are provided in other embodiments. For example, in certain embodiments the search interface illustrated in FIG. 3 is usable to search one or more of several databases, such as databases relating to particular geographical regions or to particular industries. In such embodiments, the search interface provides the user with the option to restrict the search to one or more of the multiple databases. The viewer application is configured to receive and forward criteria used to search the database 10 based on the information provided in the fields 22. In this example, the search is performed by the database administrator.

The exemplary search interface illustrated in FIG. 3 is usable to determine whether an organization already has an associated stored record in the database. If, after entering search criteria, no organization record is found and displayed, the user can cause a record to be created using information provided by the user. In such embodiments, the search interface includes a “submit new company information” button usable for this purpose.

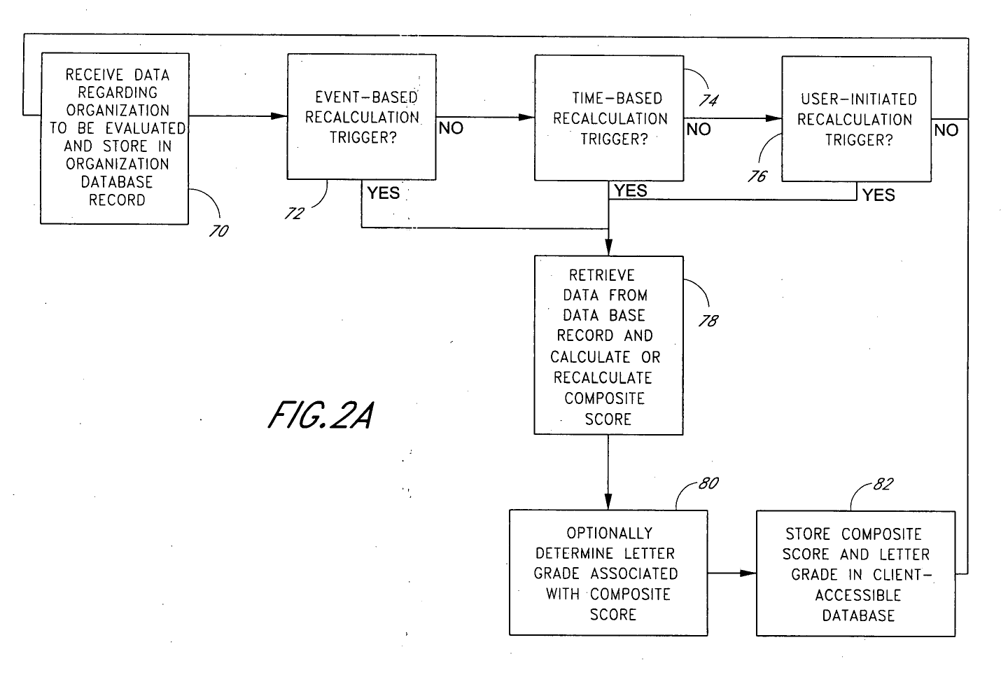

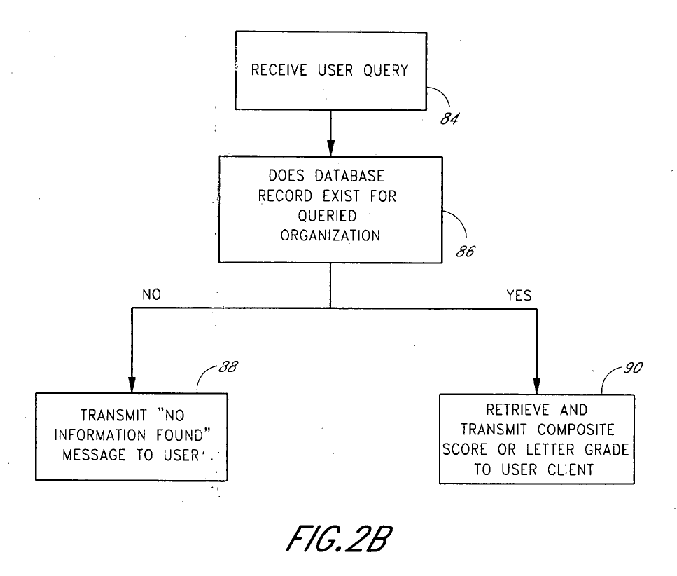

An exemplary process for using the search interface is illustrated in FIG. 2B. Specifically, a user query for a particular organization is received in operational block 84. The database administration computer 12 determines whether a record exists in the database 10 for the queried organization in an operational block 86. If not, a message to this effect is provided to the user in operational block 88. If a record does exist in the database for the queried organization, information relating to the organization is provided to the user in an operational block 90. If multiple organizations match the query submitted by the user, the user is optionally presented with a list of the potential matches.

In an exemplary embodiment, an organization to be evaluated is given points, also referred to herein as “performance designators”, based on a plurality of factors. The factors include subjective factors, objective factors, or a combination of subjective and objective factors. In embodiments wherein higher scores correspond to a better evaluation, points are awarded or are not subtracted for factors wherein the organization earns a positive ranking, while points are subtracted or are not awarded for factors wherein the organization earns a negative ranking. An exemplary selection of factors and corresponding point distributions are described below.

Factor 1: Type of Organization Factor. An organization to be evaluated is provided with a ranking on a five-category scale based upon the industry within which the organization operates. An organization that operates in an industry that is historically not problematic from a customer service standpoint is given a higher ranking, such as 1 or 2. Organizations in these industries tend to generate few consumer complaints and tend not to engage in deceptive advertising and selling practices. An organization that operates in an industry that historically or currently has a reputation for being oftentimes or predominantly deceptive or fraudulent with respect to advertising and/or selling practices is given a lower ranking, such as 4 or 5. An example of such an industry is credit correction or credit repair. In a modified embodiment, more than five or fewer than five ranking categories are used. This factor can be partially subjective because it relies on a broad-based evaluation of an entire industry, from both an historical and present-day perspective. Optionally, this factor also accounts for emerging scam and fraud trends in particular industries. Other considerations that are optionally considered under this factor for a particular industry include historical complaint experience, advertising practices, selling practices, and breach of contract prevalence. Points are assigned to the organization being evaluated based on the ranking for the type of organization. An exemplary point distribution scheme for this factor is provided in Table A; other point distribution schemes are used in other embodiments.

TABLE A

| Type of Organization | Points Awarded to |
|---|---|
| Ranking | Organization |
| 1 | +9 |
| 2 | +7 |
| 3 | +5 |
| 4 | −1 |
| 5 | −20 |

Factor 2: Length of Time of Operation Factor. An organization to be evaluated is provided with a ranking based upon how long the organization has been operating. Often consumers place significant value on working with a well-established and stable organization. For example, the failure rate for small businesses is particularly high during the first twelve months of operation, and many consumers prefer to work with organizations that will not cease to exist in the midst of an established business relationship. This factor is substantially objective because it can be evaluated based on the age of the organization, which is usually determined without subjective judgment. Points are assigned to the organization being evaluated based on how long the organization has been in operation. An exemplary point distribution scheme for this factor is provided in Table B; other point distribution schemes are used in other embodiments.

TABLE B

| Length of Time of | Points Awarded to |
|---|---|
| Operation (days) | Organization |
| 0 to 182 | −2 |
| 183 to 365 | 0 |
| 366 to 730 | +1 |
| 731 to 1095 | +2 |
| 1096 to 1825 | +3 |
| 1826 to 2555 | +4 |
| 2556 to 3650 | +6 |
| 3651 to 5475 | +7 |
| 5476 to 999999 | +8 |

Factor 3: Licensing Competency Factor. An organization to be evaluated is optionally awarded or penalized based on whether the organization is in compliance with applicable requirements relating to licensure, registration, bonding and so forth. This factor, often referred to as “competency status” is substantially objective because it can be evaluated based on the factual inquiries of (a) whether licensure, registration, bonding or the like is required, and (b) whether such requirement has been met. In cases where the requirements for licensure, registration, bonding or the like are unclear or are unknown, or where there are no requirements, no points are awarded or penalized. An exemplary point distribution scheme for this factor is provided in Table C; other point distribution schemes are used in other embodiments.

TABLE C

| Licensing | Points Awarded to |
|---|---|
| Competency | Organization |
| requirements fulfilled | +2 |
| no requirements | 0 |
| requirements unknown | 0 |
| requirements not fulfilled | −30 |

Factor 4: Complaint Volume Factor. An organization to be evaluated is awarded points based on the volume of complaints received against the organization. The complaints are received by an oversight organization, such as a governmental agency, a bar association, a consumer rights advocacy group, a better business bureau or a chamber of commerce or a combination or sub-combination thereof. In one embodiment, the complaints are received by the same entity that performs the organization evaluation. The number of complaints received by one or more of such agencies is tallied, and points are awarded to the organization being evaluated based on the total number of complaints. In a modified embodiment, different weights are optionally assigned to different complaints depending on the source of the complaint. For example, a complaint from a source considered especially reliable (such as a governmental regulatory agency) is assigned a greater weight than a complaint from a more questionable source (such as a disgruntled consumer). This factor is a substantially objective measure because counting complaints generally does not require subjective judgment. In a modified embodiment, a complaint rate is used, such as number of complaints received per unit time, per customer transaction, or per dollar of sales. For example, in one embodiment the number of complaints received within the last 36 months is used. An exemplary point distribution scheme for this factor is provided in Table D; other point distribution schemes are used in other embodiments.

TABLE D

| Complaint | Points Awarded to |
|---|---|
| Volume | Organization |
| 0 | +20 |
| 1 | +19 |
| 2 | +18 |
| 3 or 4 | +17 |
| 5 through 9 | +15 |
| 10 through 14 | +13 |
| 15 through 19 | +11 |
| 20 through 29 | +8 |
| 30 through 49 | +6 |
| 50 through 99 | +4 |
| 100 or greater | +2 |

Factor 5: Unanswered Complaints Factor. An organization to be evaluated is optionally awarded or penalized points based on the number of complaints (as evaluated under Factor 4) to which the organization has not responded, also referred to as “unanswered complaints”. In an exemplary embodiment, this information is compiled by the same entity that receives complaints about the organization. This provides an objective measure of how responsive the organization is to consumer complaints, which is generally regarded as important by many consumers. The total number of unanswered complaints received is tallied, and points are awarded to or deducted from the organization being evaluated based on the number of unanswered complaints. In a modified embodiment, a complaint answer rate is used, with points awarded to organizations that answer a large proportion of complaints, and with points deducted from organization that answer a small proportion of complaints. An exemplary point distribution scheme for this factor is provided in Table E; other point distribution schemes are used in other embodiments.

TABLE E

| Unanswered | Points Awarded to |
|---|---|
| Complaints | Organization |
| 0 | +20 |
| 1 | +10 |
| 2 | 0 |
| 3 | −10 |
| 4 or greater | −20 |

Factor 6: Unresolved Complaints Factor. An organization to be evaluated is optionally awarded or penalized points based on the number of complaints (as evaluated under Factor 4) that have not been resolved. In an exemplary embodiment, this information is compiled by the same entity that receives complaints about the organization. In such embodiments, the entity receiving consumer complaints about an organization also tracks how the organization responds (if at all) to the complaint. The organization's response is subjectively or objectively evaluated to determine if appropriate in view of the facts surrounding the complaint. Where the organization fails to adequately address the allegations, the complaint is considered unresolved. For example, the organization's response can be evaluated wholly or partially on how quickly the organization responds to the complaint, and whether the consumer indicates that the complaint was satisfactorily resolved. This advantageously provides a subjective and/or objective measure of how responsive the organization is to consumer complaints, which is generally regarded as important by many consumers. The total number of complaints received is tallied, and points are awarded to or deducted from the organization being evaluated based on the number of complaints that are unresolved. In a modified embodiment, a complaint resolution rate is used, with points awarded to organizations that answer a large proportion of complaints. An exemplary point distribution scheme for this factor is provided in Table F; other point distribution schemes are used in other embodiments.

TABLE F

| Unresolved | Points Awarded to |
|---|---|
| Complaints | Organization |
| 0 | +10 |
| 1 | +7 |
| 2 | +6 |
| 3 or 4 | +4 |
| 5 or 6 | +3 |
| 7 through 9 | +2 |
| 10 or greater | +1 |

Factor 7: Serious Complaints Factor. An organization to be evaluated is optionally awarded points based on the number of complaints (as evaluated under Factor 4) that are considered to be serious in nature. In an exemplary embodiment, this information is compiled by the same entity that receives complaints about the organization. This provides a subjective measure of the type of complaints registered against a particular organization, placing additional weight on complaints resulting from particularly grievous or fraudulent conduct. For example, in one embodiment complaints containing allegations that are not serious and are typical of the kind of problem experienced by similar businesses are discounted. Examples of particularly grievous or fraudulent conduct includes collection of money without providing services, providing a used product when a new product was paid for, and overcharging by a threshold amount. The number of serious complaints received is tallied, and points are awarded to or deducted from the organization being evaluated based on the number of serious complaints received. In a modified embodiment, a rate statistic is used, with points awarded to organizations having a small proportion of serious complaints. An exemplary point distribution scheme for this factor is provided in Table G; other point distribution schemes are used in other embodiments.

TABLE G

| Serious | Points Awarded to |
|---|---|
| Complaints | Organization |
| 0 | +15 |
| 1 | +9 |
| 2 | +6 |
| 3 | +4 |
| 4 | +3 |
| 5 or greater | 0 |

Factor 8: Complaint Analysis Factor. An organization to be evaluated is optionally awarded or penalized points based on the number of complaints (as evaluated under Factor 4) that have not been answered, that are unresolved, and that are serious (as evaluated under Factors 5, 6 and 7, respectively). This composite factor effectively puts additional weight on such complaints, since such complaints are generally of particular interest to consumers. The aggregate number of unanswered, unresolved and serious complaints received is tallied, and points are awarded to or deducted from the organization being evaluated based on the number of such complaints. In a modified embodiment, a rate statistic is used, with points awarded to or deducted from an organization based on the proportion of complaints that are considered to be unanswered, unresolved or serious. An exemplary point distribution scheme for this factor is provided in Table H; other point distribution schemes are used in other embodiments.

TABLE H

| Complaint | Points Awarded to |
|---|---|
| Analysis | Organization |
| 0 through 9 | +8 |
| 10 through 19 | +6 |
| 20 through 29 | +3 |
| 30 through 39 | +1 |
| 40 through 49 | −5 |
| 50 or greater | −12 |

Factor 9: Government Actions Factor. An organization to be evaluated is optionally penalized points if the organization has government actions filed against it. If the governmental actions are serious, additional points are optionally deducted from the organization. Examples of governmental actions include sanctions for regulatory violations, sanctions for criminal violations, or other ongoing investigations and legal proceedings. By including such information in the evaluation system described herein, consumers are not required to independently seek such information from the wide variety of governmental entities that oversee the operation of different organizations. An exemplary point distribution scheme for this factor is provided in Table I; other point distribution schemes are used in other embodiments. In one embodiment, the point deductions listed in Table I are levied for each governmental action against an organization, while in other embodiments the point deductions listed in Table I are levied once if one or more governmental actions have been taken against the organization. In one embodiment, if multiple governmental actions have been taken against an organization, points are deducted based on an assessment of the seriousness of the multiple actions taken as a whole.

TABLE I

| Government | Points Deducted |
|---|---|
| Actions | from Organization |
| none | 0 |
| minor | −8 |
| moderate | −15 |
| serious | −30 |

Factor 10: Advertising Factor. An organization to be evaluated is provided with a ranking on a three-category scale based upon the organization's advertising techniques. An organization that makes unrealistic or unsubstantiated claims in its advertising, that makes offers that cannot reasonably be carried out, or that misrepresents its goods or services in its advertising is given a high ranking, such as 3. An organization that has minor issues related to advertising, such as low price claims or other relatively minor issues is given an intermediate ranking, such as 2. An organization that does not engage in such conduct is given a lower ranking, such as 1. In a modified embodiment, more than three or fewer than three ranking categories are used. This provides a subjective evaluation of the organization's advertising techniques, advantageously providing consumers with an indication of the reliability of an organization's claims. Points are assigned to the organization being evaluated based on the ranking for the type of advertising the organization uses. An exemplary point distribution scheme for this factor is provided in Table J; other point distribution schemes are used in other embodiments.

TABLE J

| Advertising | Points Deducted |
|---|---|
| Ranking | from Organization |
| 1 | 0 |
| 2 | −10 |
| 3 | −20 |

Factor 11: Organization Background Factor. An organization to be evaluated is optionally awarded points if it provides background information regarding the organization. For example, in one embodiment, such information includes the age of the organization, other names under which the organization conducts its operations, information about the organization's principals, and the contact information for the organization, including address and telephone number. The evaluation is based on whether such background information is made available to the public, such as to consumers or to the entity conducting the evaluation of the organization. This objective measure provides, among other things, an indication to consumers of the ease of working with the organization. In one embodiment, five points are awarded to the organization if specified background information is provided, while zero points are awarded to the organization if any of the specified background information is not provided. In other embodiments, other point values are awarded or deducted from the organization.

Factor 12: Standards Compliance Factor. An organization to be evaluated is optionally awarded points if it agrees to comply with established standards for conducting operations. In a modified embodiment, the organization is optionally awarded points if it actually complies with established standards for conducting operations. In an exemplary embodiment, the standards are specified by an entity such as industry watchdog group, a chamber of commerce, a better business bureau, or a governmental regulatory agency. The standards are optionally specified by the same entity that conducts the evaluation of the organization. For example, in one embodiment the standards relate to procedures for responding to consumer complaints, procedures for dispute resolution, and advertising. This objective measure provides one indication to consumers of the reliability and trustworthiness of the organization. In one embodiment, five points are awarded to the organization if the organization has agreed to comply with particular specified standards, while zero points are awarded to the organization if the organization has not agreed to comply with the particular specified standards. In other embodiments, other point values are awarded or deducted from the organization.

Composite Organization Evaluation.

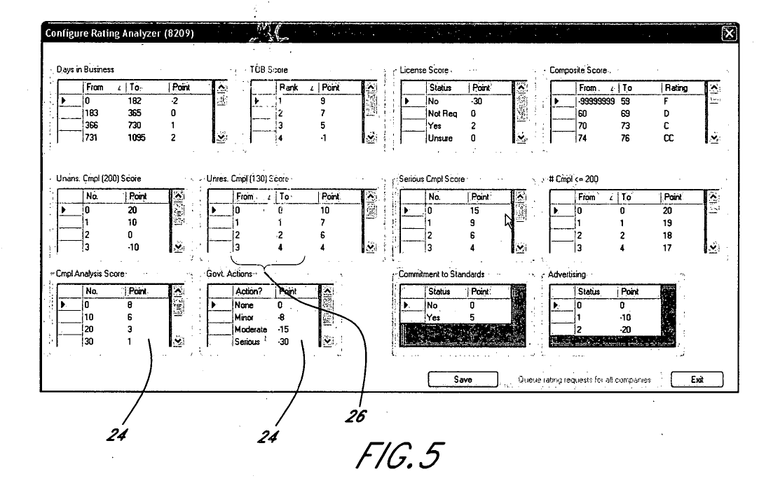

Described herein is an exemplary point distribution system. Assigning different point values to different factors manipulates the weighting of the factors in the overall evaluation. Thus, this system of factors is easily modified in embodiments where particular factors are to be emphasized or discounted. FIG. 5 is an exemplary screen shot of an interface usable to adjust the relative weight of the factors used to evaluate the organization. As illustrated, this interface allows both the assigned point values 24 and the categorization ranges 26 (where applicable) to be adjusted.

For example, if the organization's length of time of operation is considered to be of particular importance in one application, a proportionally larger number of points are awarded or deducted based on that category. Likewise, if standards compliance is considered to be of lesser importance in one application, a proportionally smaller number of points, or no points, are awarded or deducted based on that category. In modified embodiments, additional factors, fewer factors or other factors are used in the evaluation of an organization. For example, factors that are considered to be of little or no importance in a particular application are omitted altogether in such applications.

As described herein, certain factors use “counting statistics”, such as the number of complaints filed against an organization. In certain embodiments, “rate statistics” are used in place of counting statistics. Examples of analogous rate statistics include complaints per unit time, complaints per dollar of sales, or complaints per transaction. In such embodiments, using rate statistics advantageously avoids penalizing an organization with a high transaction volume.

In an exemplary embodiment, after an organization has been evaluated based on selected factors, a composite point score for the organization is calculated. Using the exemplary point distribution system described herein, higher scores correspond to a more favorable organization evaluation. Calculating a composite score that is partially dependent on a plurality of different factors provides consumers with a single score to consider when evaluating an organization. This is particularly advantageous as compared to many other evaluation systems, wherein consumers are required to consider multiple sources of information independently. Thus, certain of the embodiments herein facilitate a quick and straightforward way for consumers to evaluate an organization.

In one embodiment, a letter grade is assigned to the evaluated organization based on the composite score. The letter grading system optionally corresponds to a letter grading system conventionally used by educational facilities, thereby further facilitating a consumer's quick and easy understanding of the evaluation of the organization. One exemplary letter grading system is provided in Table K; other grading systems, for example using plus and minus grades (such as A+and A−) are used in other embodiments. Other examples of rating indicia that are used in other embodiments include stars, diamonds, other symbols and points.

TABLE K

| Organization | Exemplary |
|---|---|
| Composite Score | Letter Grade |
| 97 points and higher | AAA |
| 94 points to 96 points | AA |
| 90 points to 93 points | A |
| 87 points to 89 points | BBB |
| 84 points to 86 points | BB |
| 80 points to 83 points | B |
| 77 points to 79 points | CCC |
| 74 points to 76 points | CC |
| 70 points to 73 points | C |
| 60 points to 69 points | D |
| 59 points and lower | F |

In an exemplary embodiment, an organization's score is dynamically recalculated when new information about the organization is received. For example, when a new complaint is filed against an organization, the organization's score for Factor 4 may automatically decrease, depending on the number of complaints previously filed against the organization. Or, as another example, when an organization resolves a previously unresolved complaint, the organization's score for Factor 6 may increase, depending on the number of other unresolved complaints against the organization. In certain cases, these example events will also affect other factors as well. Therefore, in this example embodiment, the organization evaluation system is configured such that a recalculation of the organization's composite score is triggered by events such as these. In a modified embodiment, the organization's score is recalculated in response to an operator command.

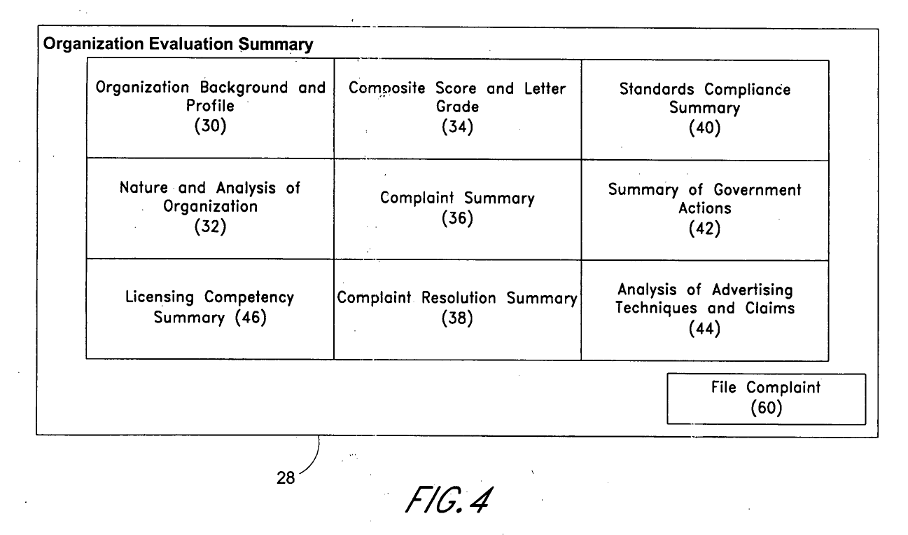

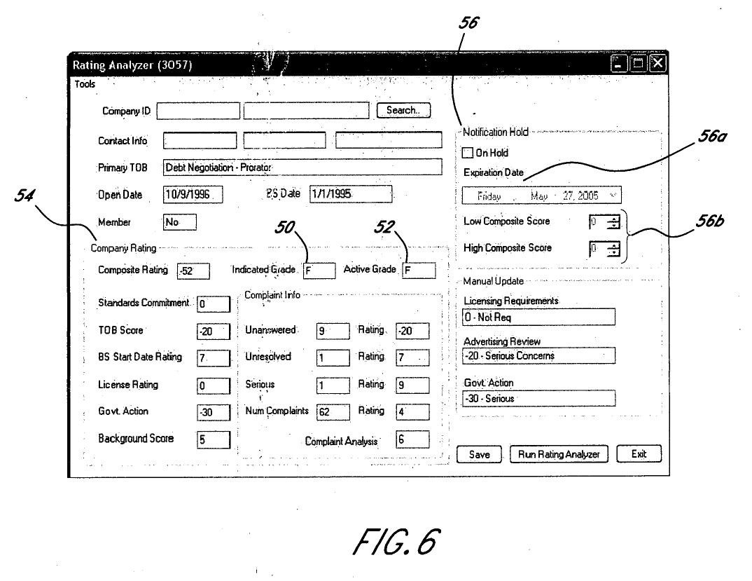

Optionally, the system disclosed herein is configured to allow a user, such as a ratings operator, to manually override the letter grade or other rating assigned to a particular organization based on the composite score. Such a feature is useful in certain cases, such as where an extremely large organization has a large number of complaints. In this example, such an organization is optionally provided with a temporary letter grade that does not account for the uninvestigated complaints, thereby avoiding unfairly punishing the organization for (a) potentially frivolous or trivial complaints, and/or (b) a number of complaints that are not significant in view of the size of the organization. An exemplary embodiment of a user interface usable to manually override an automatically computed letter grade is provided in FIG. 6. Specifically, the interface of FIG. 6 shows an indicated letter grade 50 calculated based on the organization's composite score, as well as a user-adjustable active letter grade 52. The active letter grade 52 is provided on a publicly available interface, such as the interface illustrated in FIG. 4 (as discussed in greater detail below). In a default setting, without user intervention, the indicated letter grade 50 equals the active letter grade 52.

The exemplary user interface illustrated in FIG. 6 optionally provides additional or alternative features. For example, this exemplary interface additionally or alternatively provides a summary 54 of the points assigned to an organization based on the factors used to calculate the composite score. This exemplary interface also additionally or alternatively provides a hold feature 56. The hold feature allows a user to place an expiration date 56a and/or a composite score range 56b on a user-adjusted active letter grade 52. The expiration date can be stored in the database 10 in association with the corresponding organization record. In such embodiments, the system is configured to display the user-adjusted active letter grade 52 until the expiration date 56a is met, or until the composite score falls outside the composite score range 56b. Optionally, when either or both of these conditions are met, a notification is sent to a system administrator, or to another party, that the user-adjusted active letter grade 52 is no longer being used.

An exemplary process for calculating the composite evaluation score for an organization is illustrated in FIG. 2A. In this process, data regarding an organization to be evaluated is received in an operational block 70, for example by the database administration computer 12 illustrated in FIG. 1. When a recalculation is triggered, such as by the receipt of new or revised data (see operational block 72), by a time event (for example, hourly, daily, weekly or monthly, see operational block 74), or by a user command (see operational block 76), the composite evaluation score for the organization is calculated based on points received for one or more factors in an operational block 78. Optionally, a letter grade is determined based on the calculated composite score in an operational block 80. The composite score, and optionally the corresponding letter grade, are stored in a client-accessible database 10 in an operational block 82. In an exemplary embodiment, the client-accessible database 10 is configured to allow users to view and sort organization evaluation scores stored therein, for example using a viewer application running on a client 18.

In another embodiment, the organization's composite score is alternatively or additionally recalculated after a specific time period has elapsed. For example, in one such embodiment the organization's composite score is recalculated every day, every week, or every month. Other recalculation periods are used in other embodiments. Such embodiments account for factors that are time dependent, such as the length of time an organization has been operating (Factor 2), and factors which are expressed in terms of rate statistics (for example, complaints per unit time). Optionally, the organization's composite score is additionally or alternatively recalculated in response to a user command to do so.

A schematic illustration of an exemplary interface usable to provide organization evaluation information to a user is illustrated in FIG. 4. In particular, FIG. 4 illustrates an organization evaluation summary 28 that includes multiple information summary modules that provide information regarding certain aspects of an evaluated organization. Optionally, certain of the information summary modules correspond to certain of the evaluation factors disclosed herein. The exemplary embodiment of FIG. 4 includes one or more of the following:
(a) An organization background and profile summary module 30 that provides background information about the organization, such as contact information. In embodiments wherein the organization evaluation summary 28 is provided electronically, this module optionally includes hyperlinks that link to additional, more detailed information about the organization, such as the organization's history.
(b) An organization analysis summary module 32 that provides a summary of the organization's operations. In embodiments wherein the organization evaluation summary 28 is provided electronically, this module optionally includes hyperlinks that link to additional, more detailed information, such as information about the services and/or goods provided by the organization.
(c) A composite score and letter grade summary module 34 that provides the organization's composite score and letter grade. In embodiments wherein the organization evaluation summary 28 is provided electronically, this module optionally includes hyperlinks that link to additional information about the letter grades, such as descriptions of the letter grades.
(d) A complaint summary module 36 that provides a summary of the complaints filed against the organization. In embodiments wherein the organization evaluation summary 28 is provided electronically, this module optionally includes hyperlinks that link to more detailed complaint information, such as text of complaints filed against the organization, and text of the organization's response to the complaints, if any.
(e) A complaint resolution summary module 38 that provides a summary of how complaints against the organization have been resolved, if at all. In embodiments wherein the organization evaluation summary 28 is provided electronically, this module optionally includes hyperlinks that link to more detailed information about how the organization has resolved complaints historically.
(f) A standards compliance summary module 40 that provides a summary of whether the organization has agreed to comply with established standards for conducting operations. In embodiments wherein the organization evaluation summary 28 is provided electronically, this module optionally includes hyperlinks that link to additional details regarding the standards to which the organization has or has not agreed to comply. Additional information regarding standards compliance is provided in the description of Factor 12 in this disclosure.
(g) A government action summary module 42 that provides a summary of government actions against the organization. In embodiments wherein the organization evaluation summary 28 is provided electronically, this module optionally includes hyperlinks that link to further information about particular government actions, such as legal proceedings.
(h) An advertising analysis summary module 44 that provides an analysis of the organization's advertising techniques and claims. In embodiments wherein the organization evaluation summary 28 is provided electronically, this module optionally includes hyperlinks that link to additional information about the organization's advertising, including examples of deceptive advertising, if any.
(i) A licensing competency summary module 46 that provides a summary of applicable regulatory standards for the organization, and whether the organization is in compliance with such standards. In embodiments wherein the organization evaluation summary 28 is provided electronically, this module optionally includes hyperlinks that link to additional details regarding the applicable regulatory standards for the organization. Additional information regarding standards compliance is provided in the description of Factor 3 in this disclosure.

Still referring to FIG. 4, the organization evaluation summary 28 optionally includes a hyperlink 60 that links users to a website that is usable to file a complaint against a particular organization. In embodiments wherein the organization evaluation summary 28 is not provided electronically, information regarding how to file a complaint is optionally provided. This advantageously facilitates collection of information about the evaluated organization from consumers.

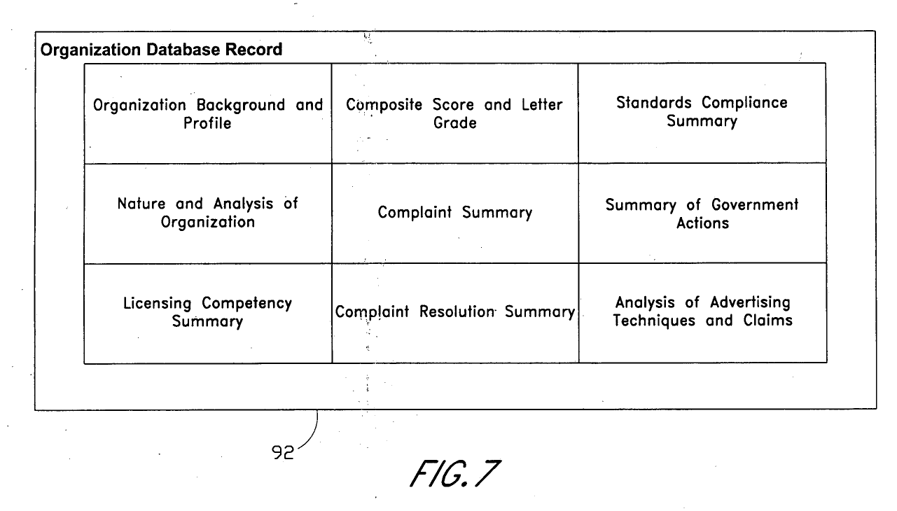

As described herein, information regarding the evaluated organization is stored in the database 10. FIG. 7 illustrates an exemplary organization database record 92 that includes information regarding the evaluation of the organization. As illustrated, the information stored in the organization database record 92 at least partially corresponds to the information presented to the user using the organization evaluation summary 28 illustrated in FIG. 4. However, in modified embodiments, additional information is stored in the organization database record 92 that is not presented to the user.

Conclusion.

The various embodiments disclosed herein provide significant improvements over conventional organization evaluation systems and methods. For example, by including consumer complaints in the evaluation calculus, consumers provide a direct contribution to an organization's evaluation. At the same time, by awarding or deducting points from an organization based on how particular complaints have been resolved, if at all, the risk of having an organization's evaluation inappropriately diminished by trivial or frivolous complaints is reduced or eliminated. This advantageously provides a more standardized and reliable approach to organizational evaluation, particularly as compared to rudimentary conventional systems that simply ask consumers to rate a business on a numerical scale, and then average all of the ratings.

While the foregoing detailed description discloses several embodiments of the present invention, it should be understood that this disclosure is illustrative only and is not limiting of the present invention. It should be appreciated that the specific configurations and operations disclosed can differ from those described above, and that the methods described herein can be used in contexts other than organizational evaluation.

We claim:

1. A database system and a database user interface comprising:
a database administration interface configured to receive information regarding an organization, an organization evaluation, and an evaluation of the organization evaluation from a first source;
a database configured to store the information regarding the organization, the organization evaluation, and the evaluation of the organization evaluation using a first database schema;
information relating to the organization that is received by the database administration interface;
an organization evaluation module configured to assign a composite performance designation to the organization based on information relating to the organization that is stored in the database, wherein the composite performance designation is stored in the database; and
a plurality of distributed client interfaces configured to access and controllably display information stored in the database to users.

2. The apparatus of claim 1, wherein the distributed client interfaces are configured to access the database using an internet.

3. The apparatus of claim 1, wherein the distributed client interfaces are configured to receive search queries for information relating to an organization in the database.

4. The apparatus of claim 1, wherein the database administration interface is configured to receive information from a user providing information using a website.

5. The apparatus of claim 1, wherein the evaluation of the organization evaluation is based at least in part on a query response from the organization regarding the evaluation.

6. The apparatus of claim 1, wherein the evaluation of the organization evaluation is received from a second source that is separate from the first source.

7. The apparatus of claim 1, wherein the organization evaluation module is further configured to assign a letter grade to the organization based on the composite performance designation.

8. The apparatus of claim 1, wherein the information relating to the organization includes information regarding advertising practices of the organization.

9. The apparatus of claim 1, wherein the distributed client interfaces are configured to provide search query language commands to the database.

10. The apparatus of claim 1, wherein the organization evaluation module is configured to reduce the composite performance designation if the evaluation of the organization evaluation is determined to be unsatisfactory.

11. A method of evaluating an organization, the method comprising:
receiving an organization evaluation;
evaluating the organization evaluation;
assigning a first performance designation to the organization based on the organization evaluation;
evaluating an organization response to the organization evaluation;
assigning a second performance designation to the organization based on the evaluation of the organization evaluation; and
compiling a cumulative score for the organization based at least partially on the first and second performance designations.

12. The method of claim 11, further comprising making the cumulative score available on an internet.

13. The method of claim 11, wherein the organization is a for-profit business entity.

14. The method of claim 11, wherein the organization is a governmental organization.

15. The method of claim 11, wherein the organization evaluation is provided by a consumer entering information using a website.

16. The method of claim 11, wherein the organization evaluation is a consumer complaint, and further comprising:
evaluating whether the organization resolved the consumer complaint; and
assigning a third performance designation to the organization based on whether the organization resolved the consumer complaint.

17. The method of claim 11, wherein a negative performance designation is assigned to the organization if the organization response to the organization evaluation is considered to be inadequate.

18. The method of claim 11, further comprising assigning a letter grade to the organization based on the cumulative score.

19. The method of claim 11, wherein the cumulative score is compiled at a periodic time interval.

20. The method of claim 11, wherein the cumulative score is compiled in response to a user command.

21. The method of claim 11, wherein the cumulative score is compiled in response to receiving a second organization evaluation.

22. The method of claim 11, further comprising:
evaluating a length of time the organization has been operating; and
assigning a third performance designation to the organization based on the length of time the organization has been operating.

23. The method of claim 11, further comprising:
evaluating an advertisement produced by the organization; and
assigning a third performance designation to the organization based on the advertisement produced by the organization.

24. The method of claim 11, wherein an adverse performance designation is assigned to the organization if the organization does not respond to the organization evaluation.

25. A system comprising:
a first computer memory storing programmable instructions to receive a complaint relating to an organization from a consumer, and an evaluation of the complaint from a complaint evaluator;
a second computer memory storing programmable instructions to assign a composite score to the organization, wherein the composite score is based at least in part on the evaluation of the complaint;
a database configured to store the complaint, the evaluation of the complaint, and the composite score; and
a network system interface configured to connect a plurality of clients to the database, wherein the plurality of clients are configured to controllably display at least a portion of data stored in the database.

26. The system of claim 25, wherein the plurality of clients are configured to display the complaint.

27. The system of claim 25, wherein the evaluation of the complaint includes an evaluation of a response to the complaint by the organization.

28. The system of claim 25, wherein the plurality of clients are configured to display the evaluation of the complaint.

29. The system of claim 25, wherein the complaint is received from a user providing information to a first computer, and wherein the evaluation of the complaint is received from a user providing information to a second computer.

30. The system of claim 25, wherein the second computer memory is configured to recalculate the composite score when the complaint is provided from the consumer.

31. The system of claim 25, wherein the second computer memory is configured to recalculate the composite score at a time interval.

32. A method of evaluating an organization, the method comprising:
defining a first factor that relates to a characteristic of the organization;
defining a second factor that relates to a characteristic of the organization;
defining a first plurality of response categories for the first factor, wherein the response categories have assigned thereto a performance designation;
defining a second plurality of response categories for the second factor, wherein the response categories have assigned thereto a performance designation;
categorizing the organization into a selected one of the first plurality of response categories based upon the first factor, and assigning the performance designation associated with the selected response category;
categorizing the organization into a selected one of the second plurality of response categories based upon the second factor, and assigning the performance designation associated with the selected response category; and
compiling a cumulative score for the organization based upon the assigned performance designations.

33. The method of claim 32, wherein the cumulative score is compiled at a periodic time interval.

34. The method of claim 32, further comprising making the cumulative score available on a computer network.

35. The method of claim 32, wherein the point values include negative values and positive values.

36. The method of claim 32, wherein the organization is a for-profit business entity.

37. The method of claim 32, further comprising:
assigning a letter grade to the organization based on the cumulative score; and
making the letter grade available on a computer network.

38. The method of claim 32, wherein the first factor is a quantity of consumer complaints registered against the organization, and wherein the second factor is a quantity of consumer complaints to which the organization has not responded.

39. The method of claim 32, wherein the first factor is a rate of consumer complaints received per unit time, and wherein the second factor is a proportion of the rate corresponding to consumer complaints to which the organization has not responded.

40. The method of claim 32, wherein the first factor is a quantity of consumer complaints registered against the organization, and wherein the second factor is an evaluation of a response by the organization to a selected consumer complaint.
